(19) United States
(12) Patent Application Publication
(10) Pub. No.: US 2023/0191546 A1
(43) Pub. Date: Jun. 22, 2023

(54) Extendable Frame Jack Assembly

(71) Applicant: Eddie Wheeler, Honolulu, HI (US)

(72) Inventor: Eddie Wheeler, Honolulu, HI (US)

(21) Appl. No.: 17/552,548

(22) Filed: Dec. 16, 2021

(51) Int. Cl. B23Q 1/64; E06B 9/52

(52) U.S. Cl. CPC B23Q 1/64; E06B 9/52

(57) ABSTRACT

An extendable frame jack assembly includes a securing member comprising a first section that slidably engages a second section. In this way the securing member has a telescopically adjustable length for extending across a variety of sizes of window frames. A pair of blocks is each coupled to opposing ends of the securing member to abut the window frame. A pair of cups is each positioned on the first side of the outer surface of a respective one of the blocks. Each of the cups is centrally positioned between the primary end and the secondary end of the respective block. Additionally, each of the cups insertably receives a respective one of the first end and the second end of the securing member.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to frame jack devices and more particularly pertains to a new frame jack device for inhibiting a window frame from collapsing inwardly while replacing a screen. The device includes a supporting member which has a telescopically adjustable length. Furthermore, the supporting member is extendable across the window frame to inhibit the window frame from collapsing inwardy.

### (2) Description of Related Art including information disclosed under 37 CFR 1.97 and 1.98

The prior art relates to frame jack devices including a door frame supporting device that includes a rectangular frame and adjustable cross members for adjusting a width of the rectangular frame for inhibiting a door frame from buckling from grout. The prior art discloses a telescopic member for supporting a table top in a deployed position. The prior art discloses a window guard that includes a panel that is positionable in a window frame and a plurality of telescopic members that are attached to the panel and which engage the window frame. The prior art discloses a structural jack that includes a pair of tubes that slidably engage a member such that the structural jack has a telescopic length and couplers that are attached to opposing ends of the structural jack for engaging framing in a building.

### BRIEF SUMMARY OF THE INVENTION

An embodiment of the disclosure meets the needs presented above by generally comprising a securing member comprising a first section that slidably engages a second section. In this way the securing member has a telescopically adjustable length for extending across a variety of sizes of window frames. A pair of blocks is each coupled to opposing ends of the securing member to abut the window frame. A pair of cups is each positioned on the first side of the outer surface of a respective one of the blocks. Each of the cups is centrally positioned between the primary end and the secondary end of the respective block. Additionally, each of the cups insertably receives a respective one of the first end and the second end of the securing member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an extendable frame jack assembly according to an embodiment of the disclosure.

FIG. 2 is a front view of an embodiment of the disclosure.

FIG. 3 is a right side view of an embodiment of the disclosure.

FIG. 4 is a back view of an embodiment of the disclosure.

FIG. 5 is a perspective in-use view of an embodiment of the disclosure.

### DETAILED DESCRIPTION OF THE INVENTION

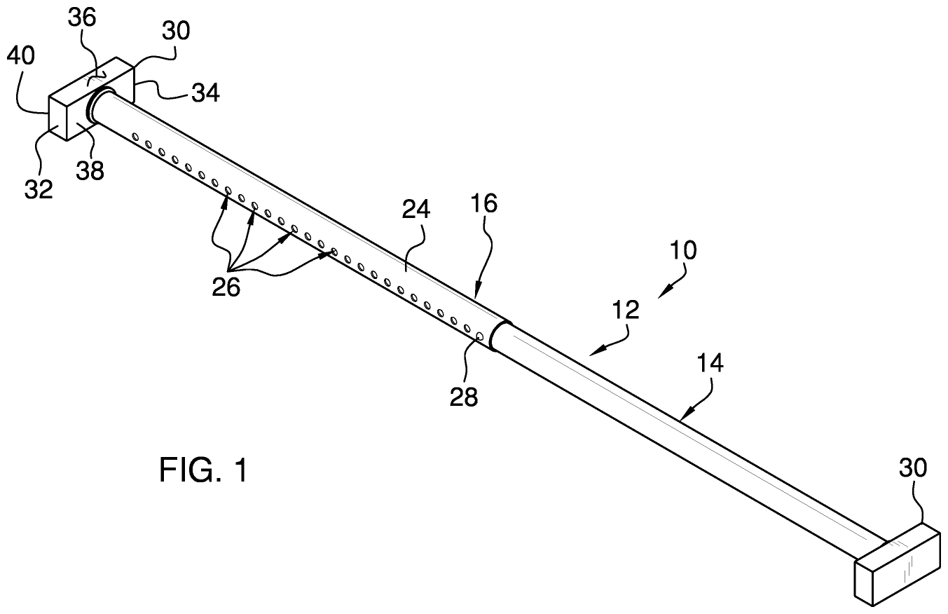

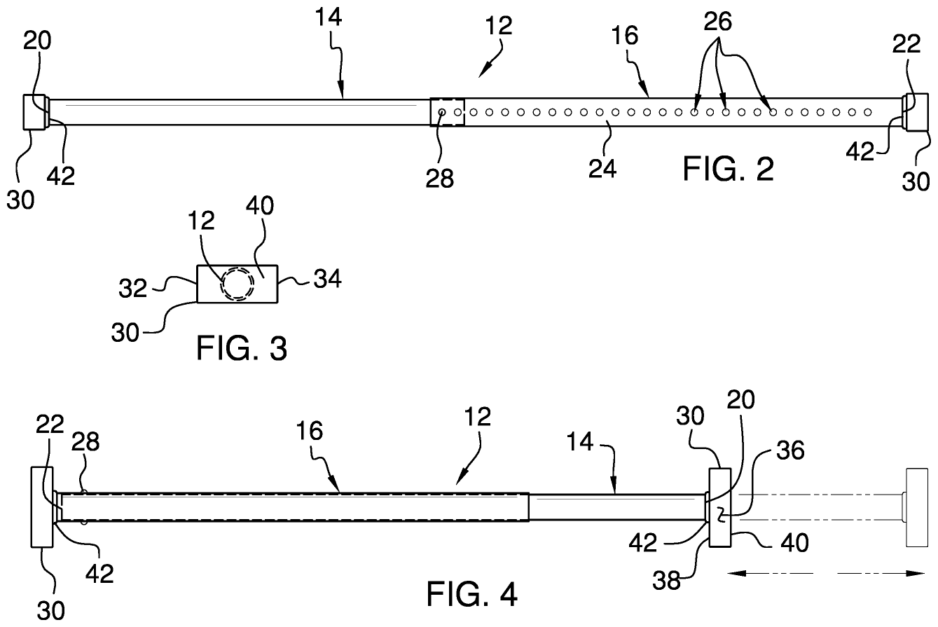

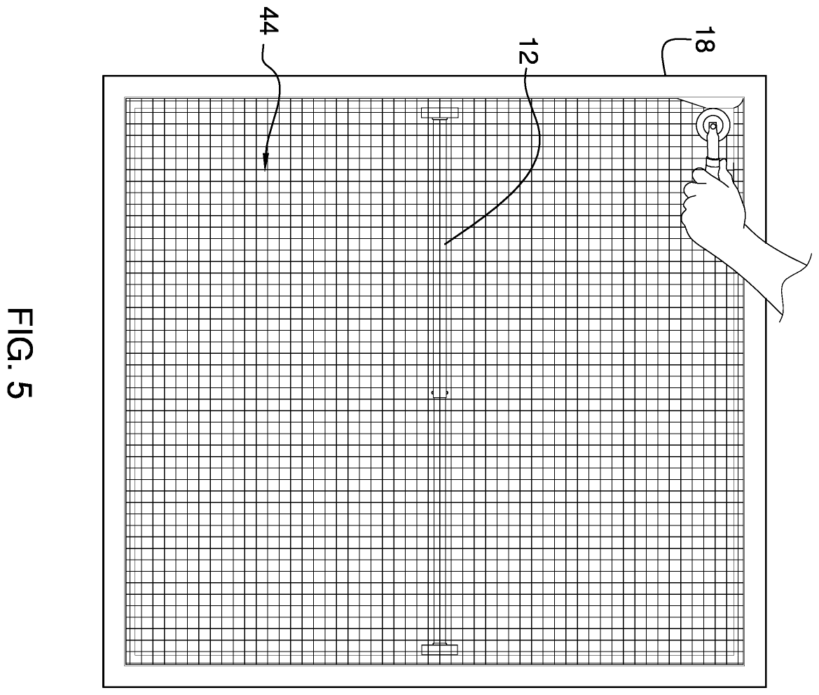

With reference now to the drawings, and in particular to FIGS. 1 through 5 thereof, a new frame jack device embodying the principles and concepts of an embodiment of the disclosure and generally designated by the reference numeral 10 will be described.

As best illustrated in FIGS. 1 through 5, the extendable frame jack assembly 10 generally comprises a securing member 12 which comprises a first section 14 that slidably engages a second section 16 such that the securing member 12 has a telescopically adjustable length. In this way the securing member 12 can be extended across a variety of sizes of window frames 18. The securing member 12 has a first end 20 and a second end 22; the first end 20 is associated with the first section 14 and the second end 22 is associated with the second section 16. An outer wall 24 of the second section 16 has a plurality of holes 26 each extending through the outer wall 24. The holes 26 are spaced apart from each other and are distributed along a substantial length of the second section 16. Furthermore, the holes 26 are spaced apart from each other a predetermined distance, which may range between approximately 0.25 inches and 0.50 inches.

A lock 28 is provided and the lock 28 is integrated into the first section 14 of the securing member 12. The lock 28 is biased to extend outwardly from the first section 14 and the lock 28 is urgeable to recess into the first section 14. The lock 28 engages a respective one of the holes 26 in the outer wall 24 of the second section 16 for retaining the securing member 12 at a selected length. In this way the securing member 12 can be fitted to the window frame 18. The window frame 18 may be a frame of a screen window or other type of window frame that is prone to collapsing inwardly during service.

A pair of blocks 30 is provided and each of the blocks 30 is coupled to opposing ends of the securing member 12. In this way each of the blocks 30 can abut the window frame 18. Each of the blocks 30 has a primary end 32, a secondary end 34 and an outer surface 36 extending between the primary end 32 and the secondary end 34, and the outer surface 36 has a first side 38 and a second side 40. The first side 38 of the outer surface 36 of each of the blocks 30 is coupled to a respective one of the first end 20 and the second end 22 of the securing member 12. In this way the second side 40 of the outer surface 36 of each of the blocks 30 can engage the window frame 18.

Each of the blocks 30 is comprised of a resiliently compressible material to enhance gripping the window frame 18. Each of the blocks 30 is elongated between the primary end 32 and the secondary end 34. Furthermore, each of the blocks 30 is positioned such that an axis extending between the primary end 32 and the secondary end 34 is oriented perpendicular to an axis extending between the first end 20 and the second end 22 of the securing member 12. In this way each of the blocks 30 can extend lengthwise along respective members of the window frame 18 when the securing member 12 is positioned to extend across the window frame 18.

A pair of cups 42 is provided and each of the cups 42 is positioned on the first side 38 of the outer surface 36 of a respective one of the blocks 30. Each of the cups 42 is centrally positioned between the primary end 32 and the secondary end 34 of the respective block 28. Additionally, each of the cups 42 insertably receives a respective one of the first end 20 and the second end 22 of the securing member 12.

In use, the securing member 12 is adjusted to a sufficient length to abut each of the blocks 30 against opposing sides of the window frame 18. In this way the window frame 18 is inhibited from collapsing inwardly when a screen 44 for the window frame 18 is being replaced. Thus, the screen 44 can be removed and replaced without causing damage to the window frame 18 as is commonplace when replacing screens 44 in a window frame 18. In this way the service life of the window frame 18 can be extended beyond several instances of removing and replacing the screen 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An extendable frame jack assembly for retaining a window frame in a preferred shape while replacing a window screen, said assembly comprising:
a securing member comprising a first section slidably engaging a second section such that said securing member has a telescopically adjustable length wherein said securing member is configured to be extended across a variety of sizes of window frames; and
a pair of blocks, each of said blocks being coupled to opposing ends of said securing member wherein each of said blocks is configured to abut the window frame, a pair of cups, each of said cups being positioned on said first side of said outer surface of a respective one of said blocks, each of said cups being centrally positioned between said primary end and said secondary end of said respective block, each of said cups insertably receiving a respective one of said first end and said second end of said securing member.

2. The assembly according to claim 1, wherein:
said securing member has a first end and a second end, said first end being associated with said first section, said second end being associated with said second section, an outer wall of said second section having a plurality of holes each extending through said outer wall, said holes being spaced apart from each other and being distributed along a substantial length of said second section, said plurality of holes being spaced apart from each other a predetermined distance; and
said assembly includes a lock being integrated into said first section of said securing member, said lock being biased to extend outwardly from said first section, said lock being urgeable to recess into said first section, said lock engaging a respective one of said holes in said outer wall of said second section for retaining said securing member at a selected length wherein said securing member is configured to be fitted to the window frame.

3. The assembly according to claim 2, wherein each of said blocks has a primary end, a secondary end and an outer surface extending between said primary end and said secondary end, said outer surface having a first side and a second side, said first side of said outer surface of each of said blocks being coupled to a respective one of said first end and said second end of said securing member wherein said second side of said outer surface of each of said blocks is configured to engage the window frame.

4. The assembly according to claim 1, wherein each of said blocks is comprised of a resiliently compressible material wherein each of said blocks is configured to enhance gripping the window frame.

5. The assembly according to claim 3, wherein each of said blocks is elongated between said primary end and said secondary end, each of said blocks being positioned such that an axis extending between said primary end and said secondary end is oriented perpendicular to an axis extending between said first end and said second end of said securing member wherein each of said blocks is configured to extend lengthwise along respective members of the window frame when said securing member is positioned to extend across the window frame.

6. The assembly according to claim 3, further comprising a pair of cups, each of said cups being positioned on said first side of said outer surface of a respective one of said blocks, each of said cups being centrally positioned between said primary end and said secondary end of said respective block, each of said cups insertably receiving a respective one of said first end and said second end of said securing member.

7. An extendable frame jack assembly for retaining a window frame in a preferred shape while replacing a window screen, said assembly comprising:
a securing member comprising a first section slidably engaging a second section such that said securing member has a telescopically adjustable length wherein said securing member is configured to be extended across a variety of sizes of window frames, said securing member having a first end and a second end, said first end being associated with said first section, said second end being associated with said second section, an outer wall of said second section having a plurality of holes each extending through said outer wall, said holes being spaced apart from each other and being distributed along a substantial length of said second section, said plurality of holes being spaced apart from each other a predetermined distance;
a lock being integrated into said first section of said securing member, said lock being biased to extend outwardly from said first section, said lock being urgeable to recess into said first section, said lock engaging a respective one of said holes in said outer wall of said second section for retaining said securing member at a selected length wherein said securing member is configured to be fitted to the window frame;
a pair of blocks, each of said blocks being coupled to opposing ends of said securing member wherein each of said blocks is configured to abut the window frame, each of said blocks having a primary end, a secondary end and an outer surface extending between said primary end and said secondary end, said outer surface having a first side and a second side, said first side of said outer surface of each of said blocks being coupled to a respective one of said first end and said second end of said securing member wherein said second side of said outer surface of each of said blocks is configured to engage the window frame, each of said blocks being comprised of a resiliently compressible material wherein each of said block is configured to enhance gripping the window frame, each of said blocks being elongated between said primary end and said secondary end, each of said blocks being positioned such that an axis extending between said primary end and said secondary end is oriented perpendicular to an axis extending between said first end and said second end of said securing member wherein each of said blocks is configured to extend lengthwise along respective members of the window frame when said securing member is positioned to extend across the window frame; and
a pair of cups, each of said cups being positioned on said first side of said outer surface of a respective one of said blocks, each of said cups being centrally positioned between said primary end and said secondary end of said respective block, each of said cups insertably receiving a respective one of said first end and said second end of said securing member.

8. An extendable frame jack system for retaining a window frame in a preferred shape while replacing a window screen, said system comprising:
a window frame comprising a plurality of intersecting members;
a screen being attachable to said window frame;
a securing member comprising a first section slidably engaging a second section such that said securing member has a telescopically adjustable length thereby facilitating said securing member to be extended across a variety of sizes of said window frames, said securing member having a first end and a second end, said first end being associated with said first section, said second end being associated with said second section, an outer wall of said second section having a plurality of holes each extending through said outer wall, said holes being spaced apart from each other and being distributed along a substantial length of said second section, said plurality of holes being spaced apart from each other a predetermined distance;
a lock being integrated into said first section of said securing member, said lock being biased to extend outwardly from said first section, said lock being urgeable to recess into said first section, said lock engaging a respective one of said holes in said outer wall of said second section for retaining said securing member at a selected length thereby facilitating said securing member to be fitted to said window frame;
a pair of blocks, each of said blocks being coupled to opposing ends of said securing member to abut said window frame, each of said blocks having a primary end, a secondary end and an outer surface extending between said primary end and said secondary end, said outer surface having a first side and a second side, said first side of said outer surface of each of said blocks being coupled to a respective one of said first end and said second end of said securing member such that said second side of said outer surface of each of said blocks can engage said window frame, each of said blocks being comprised of a resiliently compressible material to enhance gripping said window frame, each of said blocks being elongated between said primary end and said secondary end, each of said blocks being positioned such that an axis extending between said primary end and said secondary end is oriented perpendicular to an axis extending between said first end and said second end of said securing member such that each of said blocks extends lengthwise along respective intersecting members of said window frame when said securing member is positioned to extend across said window frame; and
a pair of cups, each of said cups being positioned on said first side of said outer surface of a respective one of said blocks, each of said cups being centrally positioned between said primary end and said secondary end of said respective block, each of said cups insertably receiving a respective one of said first end and said second end of said securing member.
